(19) United States
(12) Patent Application Publication
(10) Pub. No.: US 2015/0117070 A1
(43) Pub. Date: Apr. 30, 2015

(54) AC-DC CONVERTING APPARATUS AND OPERATING METHOD THEREOF

(71) Applicant: Novatek Microelectronics Corp., Hsinchu (TW)

(72) Inventors: Ying-Hsiang Wang, New Taipei City (TW); Che-Li Lin, Taipei City (TW); Chih-Jen Yen, Hsinchu City (TW)

(73) Assignee: Novatek Microelectronics Corp., Hsinchu (TW)

(21) Appl. No.: 14/184,648

(22) Filed: Feb. 19, 2014

(30) Foreign Application Priority Data
Oct. 30, 2013 (TW) 102139347

(51) Int. Cl. H02M 3/335

(52) U.S. Cl. CPC H02M 3/33507
USPC 363/21.14

(57) ABSTRACT

An AC-DC converting apparatus and operating method are provided. The AC-DC converting apparatus includes a transformer, a first energy storage unit, a first output switch, a second energy storage unit, a second output switch and a secondary-side control module. The transformer includes a primary-side winding and a secondary-side winding. The first output switch is coupled between the secondary-side winding and the first energy storage unit. The second output switch is coupled between the secondary-side winding and the second energy storage unit. The secondary-side control module monitors the first energy storage unit and the second energy storage unit, and decides time length of a conduction period of the first output switch and the second output switch according to the monitoring result.

### CROSS-REFERENCE TO RELATED APPLICATION

This application claims the priority benefit of Taiwan application serial no. 102139347, filed on Oct. 30, 2013. The entirety of the above-mentioned patent application is hereby incorporated by reference herein and made a part of this specification.

### BACKGROUND OF THE INVENTION

1. Field of the Invention

The invention relates to a power supply circuit, and particularly relates to an AC-DC converting apparatus and an operating method thereof.

2. Description of Related Art

Internal circuits of the electronic devices nowadays usually use DC voltages of a plurality of different voltage levels. Therefore, AC-DC converters are usually configured in the electronic devices to supply the internal circuits with power. The AC-DC converters are capable of converting supply mains (AC) into DC, such that the electronic devices are provided with the DC voltages required for operation. FIG. 1 is a schematic circuit view illustrating a conventional flyback converter. The conventional flyback converter includes a transformer 110, a rectifying diode 131, and an output capacitor 132. A first end and a second end of a secondary-side winding 112 of the transformer 110 are respectively coupled with an anode of the rectifying diode and a reference voltage. Two ends of the output capacitor 132 are respectively coupled with a cathode of the rectifying diode 131 and the reference voltage.

The supply mains provide AC power to a rectifier 120. The rectifier 120 converts AC into DC to transmit the same to a primary-side winding 111 of the transformer 110. A control end of a transistor 140 is coupled with a conduction control circuit 150. When the transistor 140 is conductive, power output by the rectifier 120 is stored in the primary-side winding 111 of the transformer 110. When the transistor 140 is turned off, power is transmitted from the primary-side winding 111 of the transformer 110 to the secondary-side winding 112, such that the rectifying diode 131 is forwardly conductive to charge the output capacitor 132 and generate a first output voltage at a first output end OUT_HV. The conduction control circuit 150 is capable of regulating a voltage level of the first output end OUT_HV by controlling a time duration of a conduction period of the transistor 140, thereby optimizing the voltage at the first output end OUT_HV.

However, if it is desired to generate a plurality of output voltages with different values by using the same winding, a conventional conversion circuit needs to be configured with a corresponding voltage converter to further convert the voltage at the first output end OUT_HV into other target voltages. For example, the flyback converter shown in FIG. 1 is configured to maintain the voltage at the first output end OUT_HV at A volts. A converter 160 (e.g. a boost converter) is capable of boosting the voltage at the first output end OUT_HV to B volts to supply power to a second output end OUT_LED. However, additionally configuring the converter 160 not only increases the cost, but reduces a conversion efficiency. Furthermore, the conventional flyback converter of FIG. 1 is only allowed to optimize the voltage of the first output end, but not allowed to optimize a first output voltage at the first output end OUT_HV and a second output voltage of the second output end OUT_LED simultaneously.

The techniques described above thus require further refinements to seek more feasible solutions.

### SUMMARY OF THE INVENTION

The invention provides an AC-DC converting apparatus and an operating method thereof that are capable of using the same winding to generate a plurality of output voltages with different values.

An embodiment of the invention provides an AC-DC converting apparatus, including a transformer, a first energy storage unit, a first output switch, a second energy storage unit, a second output switch, and a secondary-side control module. The transformer includes at least one primary-side winding and at least one secondary-side winding. A first end and a second end of the first output switch are respectively coupled with the first energy storage unit and a first end of the secondary-side winding. A first end and a second end of the second output switch are respectively coupled with the second energy storage unit and the first end of the secondary-side winding. The secondary-side control module is coupled with the first energy storage unit to monitor a first electrical characteristic of the first energy storage unit, and is coupled with the second energy storage unit to monitor a second electrical characteristic of the second energy storage unit. The secondary-side control module correspondingly decides a time duration of a conduction period of the first output switch according to a monitoring result of the first electrical characteristic, and correspondingly decides a time duration of a conduction period of the second output switch according to a monitoring result of the second electrical characteristic.

The invention provides an operating method of an AC-DC converting apparatus, including the following. A transformer is configured in the AC-DC converting apparatus, wherein the transformer includes at least one primary-side winding and at least one secondary-side winding. A first energy storage unit and a first output switch are configured in the AC-DC converting apparatus, wherein a first end and a second end of the first output switch are respectively coupled with a first end of the secondary-side winding and the first energy storage unit. A second energy storage unit and a second output switch are configured in the AC-DC converting apparatus, wherein a first end and a second end of the second output switch are respectively coupled with the second energy storage unit and the first end of the secondary-side winding. Power stored in the transformer is transmitted to the first energy storage unit during a conduction period of the first output switch. A first electrical characteristic of the first energy storage unit is monitored. In addition, a time duration of the conduction period of the first output switch is correspondingly decided according to a monitoring result of the first electrical characteristic. The power stored in the transformer is transmitted to the second energy storage unit during a conduction period of the second output switch. A second electrical characteristic of the second energy storage unit is monitored. In addition, a time duration of the conduction period of the second output switch is correspondingly decided according to a monitoring result of the second electrical characteristic.

Based on the above, the invention provides the AC-DC converting apparatus and the operating method thereof. The AC-DC converting apparatus uses the secondary-side control module to monitor the first and second energy storage units, and deciding the time durations of the conduction periods of the first and second output switches according to the monitoring results. Therefore, it only requires the secondary-side winding of the transformer to generate a plurality of output voltages that are optimizable and precisely regulatable without the need of additionally configuring a voltage converter.

To make the above features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a conventional AC-DC converter.

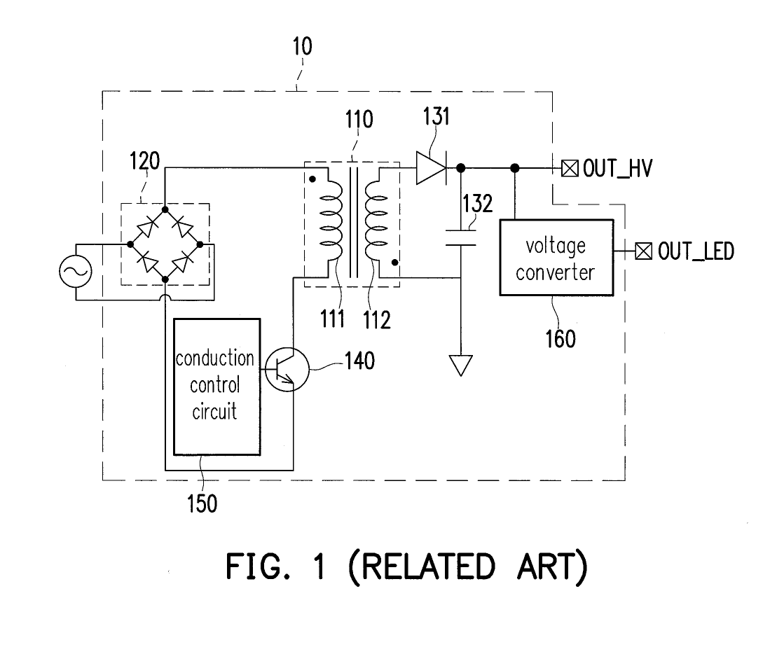

FIG. 2 is a schematic view illustrating an AC-DC converting apparatus according to an exemplary embodiment of the invention.

FIG. 3 is a flowchart illustrating an operating method of an AC-DC converting apparatus according to an exemplary embodiment of the invention.

FIG. 4 is a schematic view illustrating a first embodiment of the AC-DC converting apparatus of FIG. 2.

FIG. 5 is a waveform diagram according to the first embodiment of the invention.

FIG. 6 is a schematic view illustrating a second embodiment of the AC-DC converting apparatus of FIG. 2.

FIG. 7 is a schematic view illustrating a third embodiment of the AC-DC converting apparatus of FIG. 2.

FIG. 8 is a schematic view illustrating a fourth embodiment of the AC-DC converting apparatus of FIG. 2.

### DESCRIPTION OF THE EMBODIMENTS

Reference will now be made in detail to the exemplary embodiments of the invention, examples of which are illustrated in the accompanying drawings. The term “couple” used throughout the text hereinafter (including the claims) refers to any direct and indirect connections. For example, if a first device is described to be coupled with a second device, it is interpreted as that the first device is directly coupled with the second device, or the first device is indirectly coupled with the second device through other devices or connection means. Moreover, wherever possible, components/members/steps using the same referential numbers in the drawings and description refer to the same or like parts. Components/members/steps using the same referential numbers or using the same terms in different embodiments may cross-refer related descriptions.

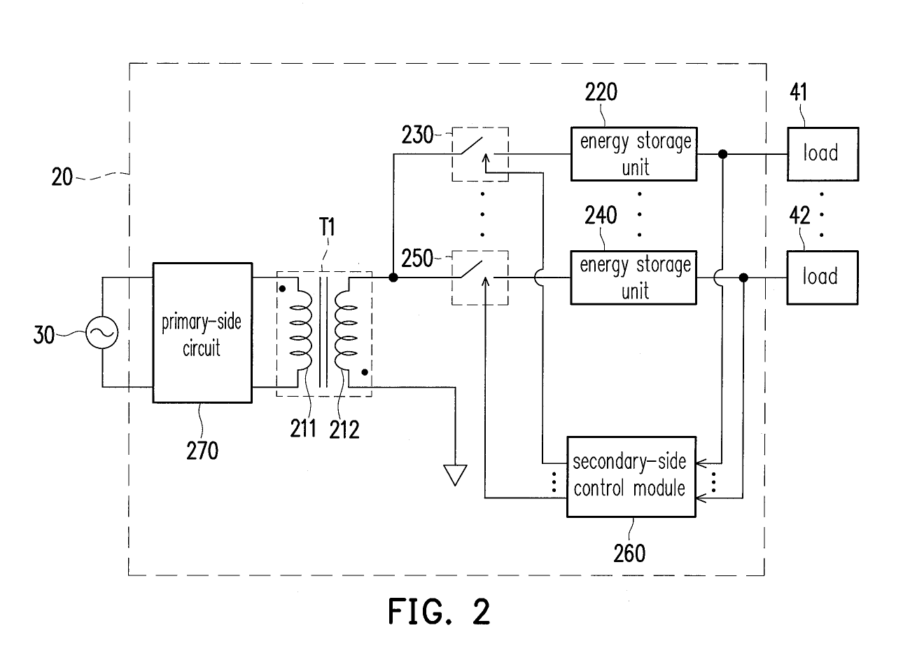

FIG. 2 is a schematic view illustrating an AC-DC converting apparatus 20 according to an exemplary embodiment of the invention. The AC-DC converting apparatus 20 is coupled between an AC power source 30 and loads 41 and 42. The AC-DC converting apparatus 20 includes a transformer T1, an energy storage unit 220, an output switch 230, an energy storage unit 240, and an output switch 250. In this embodiment, a topology of the AC-DC converting apparatus 20 may be a flyback power converter topology. However, the invention is not limited thereto.

The transformer T1 includes at least one primary-side winding 211 and at least one secondary-side winding 212. In this exemplary embodiment, power of the AC power source 30 may be transmitted to the primary-side winding 211 of the transformer T1 through a primary-side circuit 270. A first end of the output switch 230 is coupled with the energy storage unit 220, a second end of the output switch 230 is coupled with a first end of the secondary-side winding 212. A first end of the output switch 250 is coupled with the energy storage unit 240, a second end of the output switch 250 is coupled with the first end of the secondary-side winding 212. In this exemplary embodiment, a first end and a second end of the primary-side winding 211 are respectively a common-polarity terminal (i.e. a dotted terminal) and an opposite-polarity terminal (i.e. an undotted terminal), and the first end and the second end of the secondary-side winding 212 are respectively an opposite-polarity terminal and a common-polarity terminal.

A secondary-side control module 260 is coupled with the energy storage unit 220 to monitor an electrical characteristic of the energy storage unit 220, and is coupled with the energy storage unit 240 to monitor an electrical characteristic of the energy storage unit 240. In this exemplary embodiment, the electrical characteristic of the energy storage unit 220 may be a voltage difference between the energy storage unit 220 and a secondary-side reference voltage (e.g. a secondary-side ground voltage), and the electrical characteristic of the energy storage unit 240 may be a voltage difference between the energy storage unit 240 and the secondary-side reference voltage. However, the invention is not limited thereto. The secondary-side control module 260 correspondingly decides a time duration of a conduction period of the output switch 230 based on a monitoring result of the electrical characteristic of the energy storage unit 220, and correspondingly decides a time duration of a conduction period of the output switch 250 based on a monitoring result of the electrical characteristic of the energy storage unit 240.

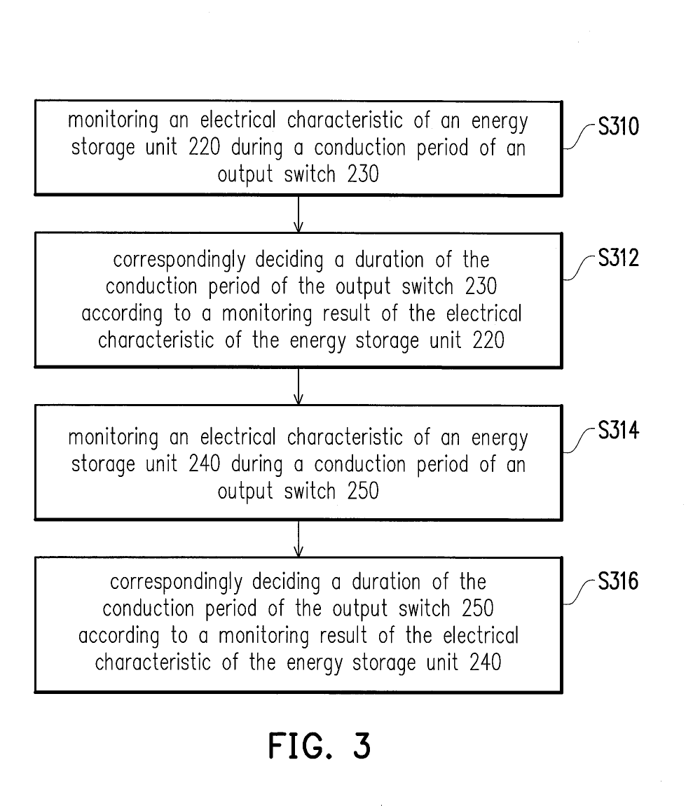

FIG. 3 is a flowchart illustrating an operating method of the AC-DC converting apparatus 20 shown in FIG. 2 according to an exemplary embodiment of the invention. Referring to FIGS. 2 and 3 simultaneously, during the conduction period of the output switch 230, power stored in the transformer T1 is transmitted to the energy storage unit 220, and the secondary-side control module 260 monitors the electrical characteristic of the energy storage unit 220 (Step S310). The electrical characteristic of the energy storage unit 220 described herein may be a voltage, current, or other electrical characteristics of the energy storage unit 220. However, the invention is not limited thereto. Thus, the energy storage unit 220 is capable of supplying power to the load 41. At Step 312, the secondary-side control module 260 correspondingly decides the time duration of the conduction period of the output switch 230 according to the monitoring result of the electrical characteristic of the energy storage unit 220. Therefore, the AC-DC converting apparatus 20 is capable of generating an accurate output voltage that is optimized to the load 41.

During the conduction period of the output switch 250, power stored in the transformer T1 is transmitted to the energy storage unit 240, and the secondary-side control module 260 monitors the electrical characteristic of the energy storage unit 240 (Step S314). The electrical characteristic of the energy storage unit 240 described herein refers to a voltage, current, or other electrical characteristics of the energy storage unit 240. However, the invention is not limited thereto. Thus, the energy storage unit 240 is capable of supplying power to the load 42. According to a design requirement of an actual product, the conduction period of the output switch 230 and the conduction period of the output switch 250 may be partially overlapped or not overlapped with each other. At Step 316, the secondary-side control module 260 correspondingly decides the time duration of the conduction period of the output switch 250 according to the monitoring result of the electrical characteristic of the energy storage unit 240. Therefore, the AC-DC converting apparatus 20 is capable of generating an accurate output voltage that is optimized to the load 42.

Based on the above, the AC-DC converting apparatus 20 and the operating method thereof described in this embodiment make use of a concept of energy distribution to store power in the primary-side winding 211 of the transformer T1 and then sequentially distributes the power stored in the transformer T1 to a plurality of outputs of the AC-DC converting apparatus 20. For example, the output switch 230 is turned on so as to distribute the power stored in the transformer T1 to the energy storage unit 220 and the load 41. In this embodiment, the secondary-side control module 260 is used to monitor the electrical characteristics (e.g. voltages) of the energy storage unit 220 and the energy storage unit 240, and correspondingly control the time durations of the conduction periods of the output switch 230 and the output switch 250. For example, when the power distributed to the energy storage unit 220 reaches a predetermined value, the secondary-side control module 260 turns off the output switch 230 and makes the output switch 250 conductive, so as to supply power stored in the transformer T1 to the next set of circuit (i.e. the energy storage unit 240 and the load 42). Thus, the AC-DC converting apparatus 20 only needs the same secondary-side winding 212 of the transformer T1 to generate a plurality of output voltages that are respectively optimized and precisely regulated without configuring an additional voltage converter.

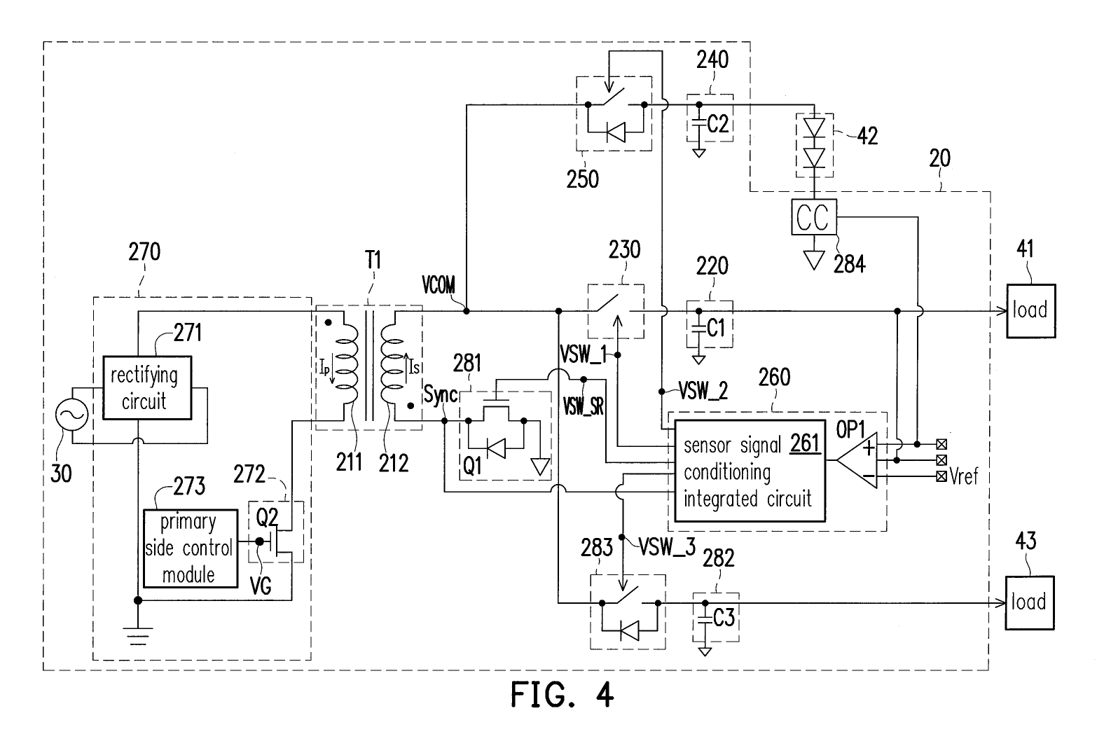

FIG. 4 is a schematic view illustrating a first embodiment of the AC-DC converting apparatus 20 of FIG. 2 according to an embodiment of the invention. The AC-DC converting apparatus 20 is coupled between an AC power source 30 and the loads 41 and 42 and a load 43. The load 42 is a light-emitting diode (LED) series, for example. In this embodiment, the secondary-side control module 260 may include a sensor signal conditioning integrated circuit (SSC-IC) 261 and a comparator OP1. However, the invention is not limited thereto. An error amplifier or other forms of feedback regulation capable of deciding an output voltage may be used in other embodiments. An output end of the comparator OP1 is coupled with the SSC-IC 261, and the SSC-IC 261 is coupled with an observation point Sync.

In this embodiment, the energy storage unit 220 is a capacitor C1, for example, and the output switch 230 may be a transistor, a transmission gate, or other types of switches. However, the invention is not limited thereto. The first end of the output switch 230 is coupled with the first end of the secondary-side winding 212. The second end of the output switch 230 is coupled with a first end of the capacitor C1, and a control end of the output switch 230 is coupled with the SSC-IC 261 of the secondary-side control module 260. A second end of the capacitor C1 is coupled with the secondary-side reference voltage (e.g. the secondary-side ground voltage or other fixed voltages). In this embodiment, the energy storage unit 240 is a capacitor C2, for example, and the output switch 250 may be a transistor, a transmission gate, or other types of switches. However, the invention is not limited thereto. The first end and the second end of the output switch 250 are respectively coupled with the first end of the secondary-side winding 212 and a first end of the capacitor C2, and a control end 250 is coupled with the SSC-IC 261 of the secondary-side control module 260. A second end of the capacitor C2 is coupled with the secondary-side reference voltage. In this embodiment, the number of the secondary-side winding 212 is one. However, the invention is not limited thereto. There may be a plurality of the secondary-side windings 212.

In this embodiment, the AC-DC converting apparatus 20 further includes a synchronous rectifying unit 281, an energy storage unit 282, and an output switch 283. In this embodiment, the energy storage unit 282 is a capacitor C3, for example, and the output switch 283 may be a transistor, a transmission gate, or other types of switches. However, the invention is not limited thereto. A first end of the output switch 283 is coupled with the first end of the secondary-side winding 212, a second end of the output switch 283 is coupled with a first end of the capacitor C3, and a second end of the capacitor C3 is coupled with the secondary-side reference voltage. In this embodiment, the synchronous rectifying unit 281 includes a synchronous rectifying switch. The synchronous rectifying switch is a transistor Q1 in this embodiment. However, the invention is not limited thereto. A first end and a second end of the transistor Q1 are respectively coupled with the second end of the secondary-side winding 212 and the secondary-side reference voltage (e.g. the secondary-side ground voltage or other fixed voltages), and a control end (gate) of the transistor Q1 is coupled with the SSC-IC 261 of the secondary-side control module 260. In this embodiment, the SSC-IC 261 of the secondary-side control module 260 is coupled with the second end (i.e. the observation point Sync) of the secondary-side winding 212, so as to monitor a voltage characteristic. In addition, the secondary-side control module 260 correspondingly controls conductive statuses of the output switch 230, the output switch 250, and/or the output switch 283 based on a monitoring result of the voltage characteristic.

In this embodiment, the energy storage unit 240 supplies power to a current path of the load 42, and the AC-DC converting apparatus 20 further includes a current detector 284. The current detector 284 is configured on the current path of the load 42 to detect a current of the load 42 and outputs a current detecting result to the secondary-side control module 260. The current detector 284 is in serial connection with the load 42 in this embodiment. Moreover, a first non-inverting input end of the comparator OP1 of the secondary-side control module 260 is coupled with the current detector 284 to receive the current detecting result. An inverting input end of the comparator OP receives a reference voltage Vref. The operator OP1 may compare the current detecting result output by the current detector 284 with the reference voltage Vref and transmits a comparison result to the SSC-IC 261. The SSC-IC 261 may correspondingly regulate the time duration of the conduction period of the output switch 250 according to a relation between the current detecting result output by the current detector 284 and the reference voltage Vref. Thus, the secondary-side control module 260 may correspondingly control and decide the time duration of the conduction period of the output switch 250 based on the current detecting result (i.e. the monitoring result of the electrical characteristic of the energy storage unit 240). Accordingly, the AC-DC converting apparatus 20 is capable of optimizing power output by the energy storage unit 240.

The first end of the energy storage unit 220 is coupled with a second non-inverting input end of the comparator OP1 of the secondary-side control module 260. The comparator OP1 may compare an electrical characteristic of the first end of the energy storage unit 220 with the reference voltage Vref and transmits a comparison result to the SSC-IC 261. Although the second non-inverting input end of the comparator OP1 is directly coupled with the first end of the energy storage unit 220 in the embodiment shown in FIG. 4, the embodiments of the invention are not limited thereto. For example, in other embodiments, a voltage-dividing circuit may be configured between the second non-inverting input end of the comparator OP1 and the first end of the energy storage unit 220. In addition, the voltage-dividing circuit may divide a voltage at the first end of the energy storage unit 220 to generate a feedback voltage to the second non-inverting input end of the comparator OP1. Therefore, the SSC-IC 261 may correspondingly regulate the time duration of the conduction period of the output switch 230 according to a relation between the electrical characteristic of the first end of the energy storage unit 220 and the reference voltage Vref. Accordingly, the secondary-side control module 260 may correspondingly control and decide the time duration of the conduction period of the output switch 230 based on the monitoring result of the electrical characteristic of the energy storage unit 220. Accordingly, the AC-DC converting apparatus 20 is capable of optimizing the power output by the energy storage unit 220.

Furthermore, the primary-side circuit 270 in this embodiment further includes a rectifying circuit 271, a primary-side control switch 271, and a primary-side control module 273. A first DC end and a second DC end of the rectifying circuit 271 are respectively coupled with the first end of the primary-side winding 211 and a primary-side reference voltage (e.g. a primary-side ground voltage), and a first AC end and a second AC end of the rectifying circuit 271 are respectively coupled with the AC power source 30. The rectifying circuit 271 is capable of converting AC power input by the AC power source 30 into DC power. The primary-side control switch 272 in this embodiment is a transistor Q2, for example. However, the invention is not limited thereto. A first end and a second end of the transistor Q2 are respectively coupled with the second end of the primary-side winding 211 and the primary-side reference voltage. The primary-side control module 273 is coupled with a control end of the transistor Q2 of the primary-side control switch 272. In addition, the primary-side control module 273 decides the power stored in the transformer T1 by controlling to a time duration of a conduction period of the transistor Q2 of the primary-side control switch 272. The secondary-side control module 260 decides power released by the transformer T1 by controlling the time durations of the conduction periods of the output switch 230, the output switch 250, and the output switch 283. The primary-side control module 273 and the secondary-side control module 260 may be configured in the same integrated circuit or in different integrated circuits. For example, in some embodiments, a function of the primary-side control module 273 may be integrated into the secondary-side control module 260, so as to save the primary-side control module 273 shown in FIG. 4. In other embodiments, the output switch 230, the output switch 250, the output switch 283 and the transistor Q1 that serves as the synchronous rectifying switch may be integrated into the SSC-IC 261 based on the design requirement of the actual product.

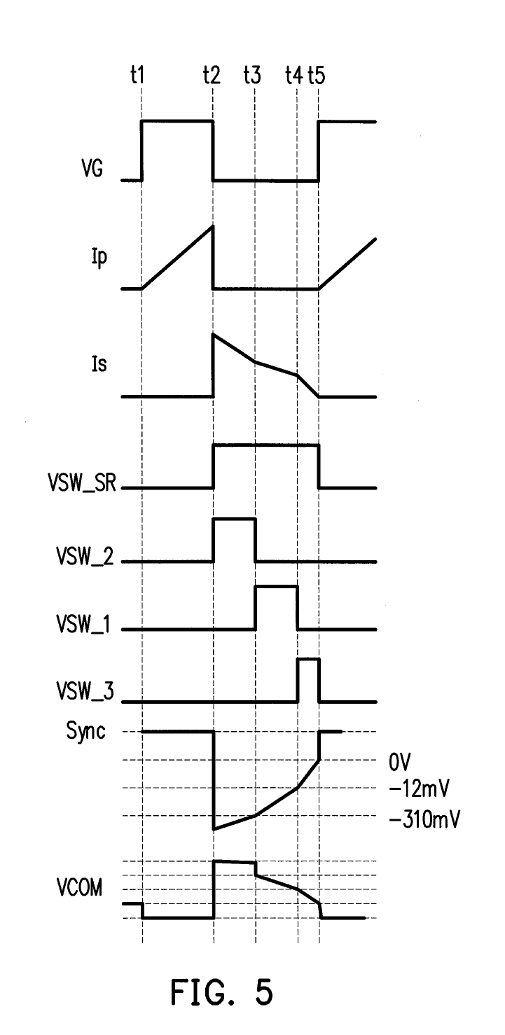

FIG. 5 is a waveform of the first embodiment of the invention. Details regarding operating processes of the AC-DC converting apparatus 20 are described hereinafter with simultaneous reference to FIGS. 4 and 5. A signal VG represents a control end voltage of the primary-side control switch 272. When the signal VG is at a high voltage level, it is indicated that the primary-side control switch 272 is conductive, and when the signal VG is at a low voltage level, it is indicated that the primary-side control switch 272 is not conductive. In a period between time points t1 and t2, the primary-side control switch 272 is conductive, making a current Ip on the primary-side winding 211 increase in the period. Namely, the primary-side circuit 270 stores power into the transformer T1 in the period between the time points t1 and t2. In the period between the time points t1 and t2, a control end voltage VSW_SR of the transistor Q1, a control end voltage VSW_1 of the output switch 230, a control end voltage VSW_2 of the output switch 250 and a control end voltage VSW_3 of the output switch 283 are at a low voltage level, indicating that the transistor Q1 as the synchronous rectifying switch, the output switch 230, the output switch 250, and the output switch 283 are not conductive. During a charging period (i.e. the period between the time points t1 and t2), power output by the rectifying circuit 271 is stored into the transformer T1 by turning on the primary-side control switch 272.

After the charging period ends, an energy-releasing period (i.e. a period between time points t2 to t5) starts. During the period between the time points t2 to t5, the signal VG is lowered to a low voltage level, turning off the primary-side control switch 272. During the period between the time points t2 to t5, the control end voltage VSW_SR of the transistor Q1 of the synchronous rectifying switch is switched from the low level to a high level, making the transistor Q1 conductive for distributing the power stored in the transformer T1 to the energy storage units 220, 240, and 282. At the time point t2 at which the transistor Q1 is conductive, a voltage of the observation point Sync is dropped to a negative voltage and lower than a predetermined reference value (e.g. −0.7V) due to an electromotive force of the secondary-side winding 212. A voltage level of the observation point Sync is responsive (related) to a quantity of the power stored in the transformer T1. Therefore, the secondary-side control module 260 may decide the quantity of the power stored in the transformer T1 by observing the voltage level of the observation point Sync. When the SSC-IC 261 of the secondary-side control module 260 receives the voltage of the observation point Sync lower than the predetermined reference value, a conductive signal is output to one of the output switches that needs to be turned on firstly in the period between the time points t2 to t5. In this embodiment, the output switch 250 is the output switch that needs to be turned on firstly. However, the invention is not limited thereto. When the voltage of the observation point Sync is at a negative voltage level, the secondary-side control module 260 sequentially turns on the output switch 250, the output switch 230, and the output switch 283, so as to distribute the power stored in the transformer T1 to the energy storage unit 240 (and the load 42), the energy storage unit 220 (and the load 41), and the energy storage unit 282 (the load 43). Details of operations during the period between the time points t2 to t5 are described below.

During a period between the time points t2 and t3, the SSC-IC 261 raises the control end voltage VSW_2 of the output switch 250 to a high level, so as to turn on the output switch 250. Therefore, the power stored in the transformer T1 may be distributed to the energy storage unit 240 and the load 42 during the period between the time points t2 and t3, making a current Is on the secondary-side winding 212 decrease (as shown in FIG. 5). During the conduction period of the output switch 250, the secondary-side control module 260 monitors the voltage of the energy storage unit 240 and/or a current flowing through the load 42, so as to optimize the power output by the energy storage unit 240. When power distributed to the energy storage unit 240 reaches a predetermined value, e.g. when the voltage of the energy storage unit 240 reaches a nominal voltage level of the load 42 and/or when the current flowing through the load 42 reaches a nominal current level of the load 42, the secondary-side control module 260 turns off the switch 250 and makes the output switch 230 conductive (when a period between the time points t3 and t4 starts), so as to supply power stored in the transformer T1 to the next set of circuit (i.e. the energy storage unit 220 and the load 41).

During the period between the time points t3 and t4, the SSC-IC 261 raises the control end voltage VSW_1 of the output switch 230 to a high voltage level, so as to make the output switch 230 conductive during the period between the time points t3 and t4. Therefore, the power stored in the transformer T1 may be distributed to the energy storage unit 220 and the load 41 during a period between the time points t3 and t4, making the current Is on the secondary-side winding 212 decrease. During the conduction period of the output switch 230, the secondary-side control module 260 monitors the voltage of the energy storage unit 220, so as to optimize the power output by the energy storage unit 220. When power distributed to the energy storage unit 220 reaches a predetermined value, e.g. when the voltage of the energy storage unit 220 reaches a nominal voltage level of the load 41, the secondary-side control module 260 turns off the switch 230 and makes the output switch 283 conductive (when a period between the time points t4 and t5 starts), so as to supply power stored in the transformer T1 to the next set of circuit (i.e. the energy storage unit 282 and the load 43).

During the period between the time points t4 and t5, the SSC-IC 261 raises the control end voltage VSW_3 of the output switch 283 to a high voltage level, so as to make the output switch 283 conductive during the period between the time points t4 and t5. Therefore, the power stored in the transformer T1 may be distributed to the energy storage unit 282 and the load 43 during the period between the time points t4 and t5, making the current Is on the secondary-side winding decrease. During the conduction period of the output switch 283, the secondary-side control module 260 monitors a voltage of the energy storage unit 282, so as to optimize the power output by the energy storage unit 282. When the power distributed to the energy storage unit 282 reaches a predetermined value, e.g. when the voltage of the energy storage unit 282 reaches a nominal voltage level of the load 43, the secondary-side control module 260 turns off the output switch 283.

By observing a voltage of a common voltage observation point VCOM (as shown in FIG. 5, for example) in the circuit shown in FIG. 4, it is understood that the AC-DC converting apparatus 20 is capable of individually regulating the voltage of the energy storage unit 220, the voltage of the energy storage unit 240, and the voltage of the energy storage unit 282 without configuring an additional voltage converter. Thus, the AC-DC converting apparatus 20 is capable of using the same secondary-side winding of the transformer to generate a plurality of output voltages that are optimized and precisely regulated.

In this embodiment, during the charging period (i.e. the period between the time points t1 to t2), the conduction period of the output switch 230, the conduction period of the output switch 250, the conduction period of the output switch 283 are not overlapped with each other. There is no dependency between operations of the output switch 230, the output switch 250, and the output switch 283. However, the invention is not limited thereto. For example, in other embodiments, the conduction periods of the output switches 230, 250, and 283 may be configured to be partially overlapped with each other based on the practical design/application requirement. In another example, although the embodiment shown in FIG. 5 sequentially turns on the output switch 250, the output switch 230, and the output switch 283, other sequences of conduction may be used in other embodiments based on the practical design/application requirement. For example, a sequence of sequentially turning on the output switch 230, the output switch 250, and the output switch 283 may be used.

Referring to FIG. 5, in this embodiment, when a period of supplying power to a first power output channel (i.e. the period between the time points t2 and t3) ends, the voltage of the observation point Sync rises to −310 mV (for an illustrative purpose only, the invention is not limited thereto). When a period of supplying power to a second power output channel (i.e. the period between the time points t3 and t4) ends, the voltage of the observation point Sync rises to −12 mV (for an illustrative purpose only, the invention is not limited thereto). And when a period of supplying power to a third power output channel (i.e. the period between the time points t4 and t5) ends, the voltage of the observation point Sync rises to 0 V (for an illustrative purpose only, the invention is not limited thereto). Through observation, it is understood that the voltage level of the observation point Sync is responsive (related) to a residual of the power stored in the transformer T1. Thus, the secondary-side control module 260 may determine the residual of the power stored in the transformer T1 when the energy-releasing period ends (e.g. at the time point 5 shown in FIG. 5) according to the voltage level of the observation point Sync, and notify the primary-side control module 273 with the residual of the power stored in the transformer T1. The primary-side control module 273 may correspondingly regulate the time period of the conduction period of the primary-side control switch 272, namely regulate a time duration of the charging period (i.e. the period between the time points t1 and t2 shown in FIG. 5), according to the residual of the power stored in the transformer T1 when the energy-releasing period ends.

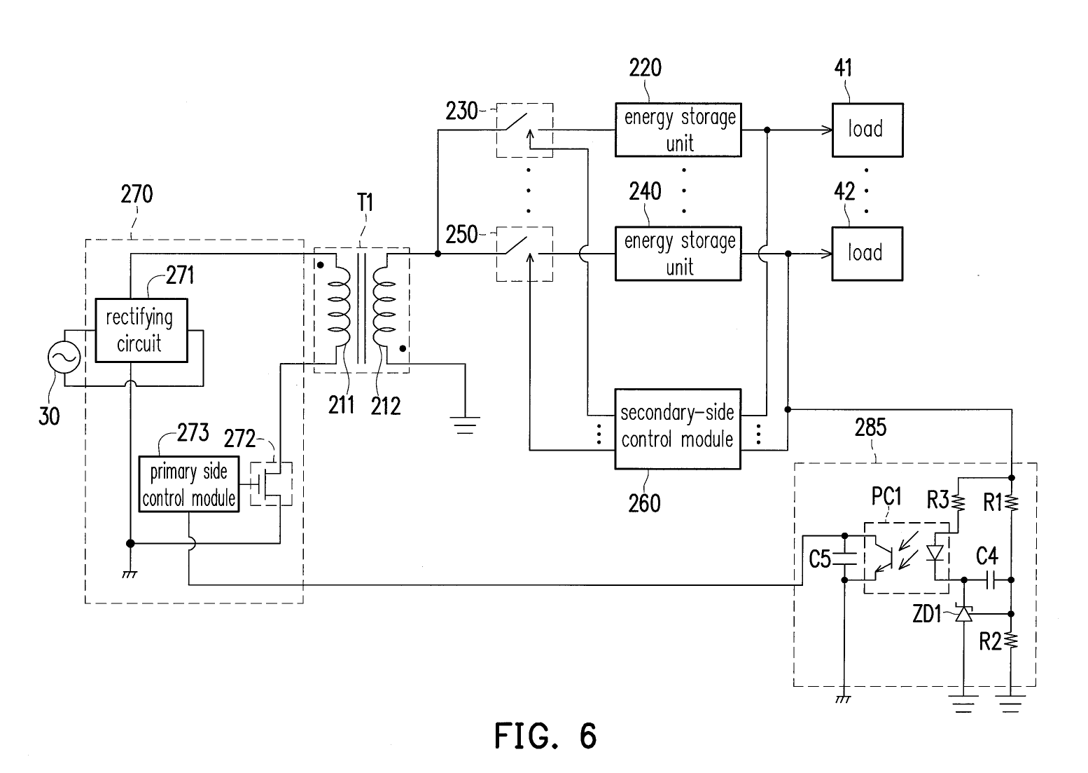

FIG. 6 is a schematic view illustrating a second embodiment of the AC-DC converting apparatus 20 of FIG. 2 according to a second embodiment of the invention. The embodiment shown in FIG. 6 may be embodied with reference to the relevant descriptions of FIGS. 4 and 5. In the embodiment shown in FIG. 6, the AC-DC converting apparatus 20 may further include a feedback module 285. A sensing end of the feedback module 285 is coupled with the energy storage unit 240 to monitor the electrical characteristic of the energy storage unit 240. In this embodiment, the electrical characteristic is the voltage of the energy storage unit 240. An output end of the feedback module 285 is coupled with the primary-side control module 273, so as to provide a corresponding information of the electrical characteristic of the energy storage unit 240. The primary-side control module 273 correspondingly controls and decides the conduction period of the primary-side control switch 272 according to the corresponding information.

In this embodiment, the feedback module 285 includes an optical coupler PC1, resistors R1 to R3, capacitors C4 and C5, and a Zener diode ZD1. A first end of the resistor R1 is coupled with the energy storage unit 240. A first end and a second end of the resistor R2 are respectively connected to a second end of the resistor R1 and the secondary-side reference voltage (e.g. the secondary-side ground voltage or other fixed voltage). A first end of the resistor R3 is coupled with the energy storage unit 240. The first end of the resistor R3 is the sensing end of the feedback module 285. A first end of the capacitor C4 is coupled with the second end of the resistor R1. A cathode of the Zener diode ZD1 is coupled with a second end of the capacitor C4, and an anode of the Zener diode ZD1 is coupled with the secondary-side reference voltage. A reference end of the Zener diode ZD1 is coupled with the second end of the resistor R1 and the first end of the resistor R2. In this embodiment, the Zener diode ZD1 may be a TL431 Zener diode manufactured by Texas Instruments or other manufacturers. However, the invention is not limited thereto. A first end of a light-emitting part of the optical coupler PC1 is coupled with a second end of the resistor R3, a second end of the light-emitting part of the optical coupler PC1 is coupled with the second end of the capacitor C4. A first end of a light-sensing part of the optical coupler PC1 is coupled with the primary-side control module 273 to provide the corresponding information, and the first end of the light-emitting part of the optical coupler PC1 is the output end of the feedback module 285. A second end of the light-sensing part of the optical coupler PC1 is coupled with the primary-side reference voltage. A first end of the capacitor C5 is coupled with the first end of the light-sensing part of the optical coupler PC1, and a second end of the capacitor C5 is coupled with the second end of the light-sensing part of the optical coupler PC1.

When the sensing end of the feedback module 285 senses the voltage of the energy storage unit 240, a current may flow through the light-emitting part of the optical coupler PC1 and the Zener diode ZD1. When the voltage of the energy storage unit 240 changes, the current flowing through the light-emitting part of the optical coupler PC1 changes, making a luminescence intensity of the light-emitting part change correspondingly. An output voltage output from the feedback module 285 to the primary-side control module 273 correspondingly changes as well, thereby changing the time duration of the conduction period of the primary-side control switch 272. For example, when the voltage of the energy storage unit 240 increases, voltage divisions of the resistors R1 and R2 increase accordingly. A voltage at the reference end of the Zener diode ZD1 increases, so the current flowing through the Zener diode ZD1 and the light-emitting part of the optical coupler PC1 increases. Thus, the luminescence intensity of the light-emitting part of the optical coupler PC1 increases, making the output voltage at the output end of the feedback module 285 increase. When the primary-side control module 273 receives the increased output voltage, the time duration of the conduction period of the primary-side control switch 272 is shortened. By employing an optical coupling feedback technique, a variable or self-optimizable voltage may be output. Based on the above, the AC-DC converting apparatus 20 described in the second embodiment uses the optical coupling feedback technique to feedback with respect to the voltage, thereby further facilitating a conversion efficiency of the invention.

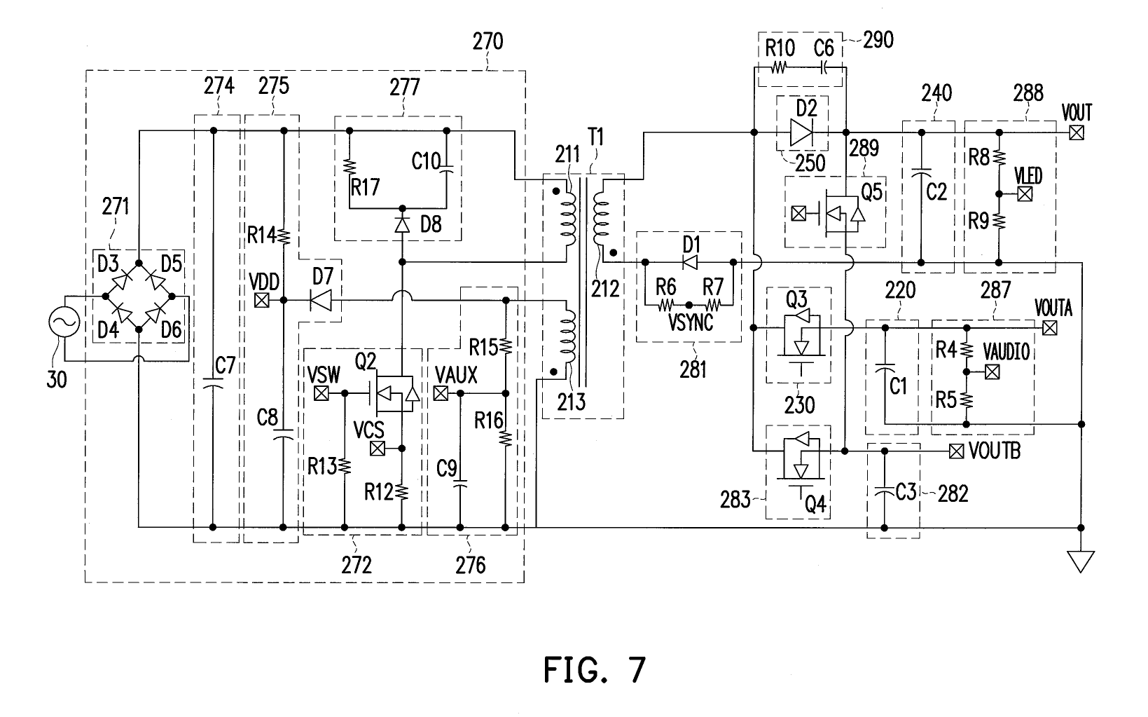

FIG. 7 is a schematic view illustrating a second embodiment of the AC-DC converting apparatus 20 of FIG. 2 according to a third embodiment of the invention. The embodiment shown in FIG. 7 may be embodied with reference to the relevant descriptions of FIGS. 4 to 6. In the embodiment shown in FIG. 7, the primary-side circuit 270 includes the rectifying circuit 271, the primary-side control circuit 272, a filter circuit 274, a chip startup circuit 275, an auxiliary voltage circuit 276, and a snubber circuit 277. In addition, the embodiment further includes the energy storage unit 282, the output switch 283, a monitor circuit 287, a monitor circuit 288, a discharge circuit 289 and a snubber circuit 290. In this embodiment, the primary-side winding of the transformer T1 further includes the first primary-side winding 211 and a second primary-side winding (referred to as a primary-side auxiliary winding 213). The primary-side auxiliary winding 213 is coupled with the chip startup circuit 275 to form a primary-side regulating (PSR) circuit.

The rectifying circuit 271 in this embodiment includes diodes D3 to D6. An anode of the diode D3 is coupled with the first AC end of the rectifying circuit 271 and a cathode of the diode D4, and a cathode of the diode D3 is coupled with the first DC end of the rectifying circuit 271 and a cathode of the diode D5. An anode of the diode D4 is coupled with the second DC end of the rectifying circuit 271 and an anode of the diode D6. An anode of the diode D5 is coupled with the second AC end of the rectifying circuit 271 and a cathode of the diode D6. An AC current provided by the AC power source 30 flows to the rectifying circuit 271 through the first and the second AC ends of the rectifying circuit and is processed by the diodes D3 to D6. Then, a DC current flows from the first DC end for the AC-DC converting apparatus 20 to use.

A first end and a second end of the primary-side auxiliary winding 213 are respectively an opposite-polarity terminal and a common-polarity terminal in this embodiment. The primary-side auxiliary winding 213 has two functions, one of which is to provide a PSR feedback, and the other is to generate an auxiliary voltage for a primary-side control module (not shown, details of which may be embodied with reference to the description of the primary-side control module 273 shown in FIG. 4) to use.

The primary-side control switch 272 includes a transistor Q2, a resistor R12 and a resistor R13. A first end of the transistor Q2 is coupled with the second end of the primary-side winding 211. A control end of the transistor Q2 is coupled with the primary-side control module to receive a control signal VSW. A first end of the resistor R12 is coupled with a second end of the transistor Q2. A second end of the resistor R12 is coupled with the primary-side reference voltage (e.g. the primary-side ground voltage or other fixed voltages). A first end of the resistor R13 is coupled with the control end of the transistor Q2. A second end of the resistor R13 is coupled with the primary-side reference voltage. The resistor R13 is a pull-down resistor capable of normally keeping the control end of the transistor Q2 at a voltage close to the primary-side reference voltage. A current detection point VCS configured at the first end of the resistor R12 serves to detect a current value. For example, a current protection apparatus is activated when there is an overly large current. In this embodiment, the primary-side reference voltage and the secondary-side reference voltage are at a common point, indicating that the primary-side reference voltage is the secondary-side reference voltage. However, the primary- and secondary-side reference voltages in other embodiments may not be at a common point.

The filter circuit 274 in this embodiment includes a capacitor C7. A first end of the capacitor C7 is coupled with the first DC end of the rectifying circuit 271 and the first end of the primary-side winding 211 of the transformer T1. A second end of the capacitor C7 is coupled with the second DC end of the rectifying circuit 271 and the primary-side reference voltage. The capacitor of the filter circuit 274 is configured to filter noise of power output by the first DC end and the second DC end of the rectifying circuit 271.

Two ends of the chip startup circuit 275 are respectively coupled with the first DC end of the rectifying circuit 271 and the primary-side control module (details of which may be embodied with reference to the description of the primary-side control module 273 shown in FIG. 4). In this embodiment, the chip startup circuit 275 includes a resistor R14, a capacitor C8 and a diode D7. A first end of the resistor R14 is coupled with the first end of the primary-side winding 211 and the first DC end of the rectifying circuit 271, and a second end of the resistor R14 is coupled with a power source pin VDD of the primary-side control module. The power source pin VDD provides power to the primary-side control module (details of which may be embodied with reference to the description of the primary-side control module 273 shown in FIG. 4) and/or the secondary-side control module 260 (as shown FIG. 2). A cathode of the diode D7 is coupled with the second end of the resistor R14. An anode of the diode D7 is coupled with the first end of the primary-side auxiliary winding 213. A first end of the capacitor C8 is coupled with the second end of the resistor R14, and a second end of the capacitor C8 is coupled with the primary-side reference voltage. The second end of the primary-side auxiliary winding 213 is coupled with the primary-side reference voltage. The resistor R14 in this embodiment may be a pull-up resistor capable of normally keeping the power source pin VDD of the primary-side control module 271 at a high level. When the power source starts up, an input voltage charges the capacitor C8 through the resistor R14. When a voltage at the first end of the capacitor C8 reaches a startup threshold voltage, the primary-side control module starts up. A voltage of the primary-side auxiliary winding 213 rectified by the diode D7 is also transmitted to the primary-side control module 273 and charges the capacitor C8.

The auxiliary voltage circuit 276 includes resistors R15 and R16 and a capacitor C9. A first end of the resistor R15 is coupled with the opposite-polarity terminal of the primary-side auxiliary winding 213, and a second end of the resistor R15 is coupled with the primary-side control module (details of which may be embodied with reference to the description of the primary-side control module 273 shown in FIG. 4). A first end of the resistor R16 is coupled with a second end of the resistor R15. A second end of the resistor R16 is coupled with the common-polarity terminal of the primary-side auxiliary winding 213 and the primary-side reference voltage. A first end of the capacitor C9 is coupled with the first end of the resistor R16, and a second end of the capacitor C9 is coupled with the primary-side reference voltage. The auxiliary voltage circuit 276 is configured to provide an auxiliary voltage VAUX (associated with voltages at the two ends of the primary-side auxiliary winding 213) for the primary-side control module to use.

A first end of the snubber circuit 277 is coupled with the first end of the primary-side winding 211. A second end of the snubber circuit 277 is coupled with the second end of the primary-side winding 211. The snubber circuit 277 of this embodiment is implemented with a circuit structure including a resistor R17, a capacitor C10, and a diode D8. A first end of the resistor R17 is coupled with the rectifying circuit 271 and the first end of the primary-side winding 211 of the transformer T1. A first end of the capacitor C10 is coupled with the first end of the primary-side winding 211. A second end of the capacitor C10 is coupled with a second end of the resistor R17. A cathode of the diode D8 is coupled with the second end of the resistor R17 and the second end of the capacitor C10. An anode of the diode D8 is coupled with the second end of the primary-side winding 211 of the transformer T1. Specifically speaking, the snubber circuit 277 serves to absorb energy generated from leakage inductance of the transformer T1.

The output switch 230 is coupled with the first end of the secondary-side winding 212. The output switch 230 may be a transistor Q3. However, the invention is not limited thereto. The capacitor C1 of the energy storage unit 220 is coupled with the output switch 230. The monitor circuit 287 is coupled with the capacitor C1 of the energy storage unit 220. The monitor circuit 287 includes resistors R4 and R5. A first end of the resistor R4 is coupled with the first end of the capacitor C1 of the energy storage unit 220. A second end of the resistor R4 is coupled with a first end of the resistor R5. A second end of the resistor R5 is coupled with the secondary-side reference voltage (e.g. the secondary-side ground voltage or other fixed voltages). The monitor circuit 287 serves to divide a voltage of the capacitor C1 of the energy storage unit 220, and transmit a voltage division VAUDIO to the secondary-side control module 260 (as shown in FIG. 2). The secondary-side control module is informed with the electrical characteristic (e.g. voltage) of the energy storage unit 220 according to the voltage division VAUDIO.

In this embodiment, the output switch 250 may be a diode D2. However, the invention is not limited thereto. An anode of the diode D2 is coupled with the first end of the secondary-side winding 212, and a cathode of the diode D2 is coupled with the energy storage unit 240. When a cathode voltage of the diode D2 is higher than an anode voltage, the diode D2 is in a turn-off state. Thus, the diode D2 may be considered as an output switch. The monitor circuit 288 is coupled with the capacitor C2 of the energy storage unit 240. The monitor circuit 288 includes resistors R8 and R9. A first end of the resistor R8 is coupled with the first end of the capacitor C2 of the energy storage unit 240, and a second end of the resistor R8 is coupled with a first end of the resistor R9. A second end of the resistor R9 is coupled with the secondary-side reference voltage (e.g. the secondary-side ground voltage or other fixed voltages). The monitor circuit 288 serves to divide a voltage of the capacitor C2 of the energy storage unit 240 and transmit a voltage division VLED to the secondary-side control module (details of which may be embodied with reference to the description of the secondary-side control module 260).

Two ends of the snubber circuit 290 are respectively coupled with an anode end and a cathode end of the diode D2. The snubber circuit 290 includes a resistor R10 and a capacitor C6. A first end of the resistor R10 is coupled with the anode end of the diode D2. A second end of the resistor R10 is coupled with a first end of the capacitor C6. A second end of the capacitor C6 is coupled with the cathode end of the diode D2. The snubber circuit 290 is capable of filtering an impulse generated when the diode D2 switches between turn-on and turn-off states.

The output switch 283 is coupled with the first end of the secondary-side winding 212. The output switch 283 may be a transistor Q4. However, the invention is not limited thereto. The capacitor C3 of the energy storage unit 282 is coupled with the output switch 283. In this embodiment, a primary-side regulation technique is used to control and regulate the output voltage of the energy storage unit 282. This technique is implemented by using circuit structures including the diode D7, the transistors R15 and R16, and the capacitors C8 and C9 in the chip startup circuit 275 and the auxiliary voltage circuit 276. The principle of primary-side regulation is to detect an output voltage variance of the secondary-side by detecting voltage variance of the primary-side auxiliary winding 213. During the energy-releasing period, the output voltage and a positive conductive voltage drop of the synchronous rectifying unit 281 are reflected in the primary-side auxiliary winding 213, and the voltages at the two ends of the primary-side auxiliary winding 213 are responsive to the output voltage. The residual of the power stored in the transformer T1 during the energy-releasing period is reflected in an output voltage of the output switch 283 that is finally turned on. Thus, in this embodiment, the voltages at two ends of the primary-side auxiliary winding 213 are related to the output voltage of the output switch 283 that is finally turned on. The auxiliary voltage VAUX responsive to the voltages at the two ends of the primary-side auxiliary winding 213 is fed back to the primary-side control module (details of which may be embodied with reference to the description of the primary-side control module 273 shown in FIG. 4). Thus, the primary-side control module is capable of regulating the time duration of the conduction period of the transistor Q2 of the primary-side control switch 272 according to the auxiliary voltage VAUX, and correspondingly regulating the time duration of the conduction period of the output switch 283. By using a primary-side regulation feedback technique, the output voltage of the output switch 283 that is finally turned on may be maintained at a constant voltage.

In this embodiment, when the switches 230 and 283 are turned off, the power stored in the transformer T1 is transmitted to the energy storage unit 240, such that an output voltage VOUT is maintained at the nominal voltage (e.g. 55V, but the invention is not limited thereto) of the load 42 (shown in FIG. 2). The secondary-side control module 260 (shown in FIG. 2) may monitor a cross voltage of the capacitor C2 of the energy storage unit 240 by using the monitor circuit 288. When the voltage of the capacitor C2 of the energy storage unit 240 reaches the nominal voltage level of the load 42 coupled with the capacitor C2 and/or when the current flowing through the load 42 coupled with the capacitor C2 reaches the nominal current level of the load 42, the secondary-side control module 260 may make the output switch 230 conductive, so as to supply power stored in the transformer T1 to the next set of circuit (i.e. the energy storage unit 220 and the load thereof). Since the output switch is conductive, the anode voltage of the diode D2 is pulled down. When the cathode voltage of the diode D2 is higher than the anode voltage, the diode D2 is in a turn-off state. Thus, the diode D2 is capable of maintaining the voltage of the capacitor C2 of the energy storage unit 240.

During the conduction period of the output switch 230, the secondary-side control module may monitor a cross voltage of the energy storage unit 220 by using the monitor circuit 287. When the output voltage VOUTA reaches a nominal voltage level of a first load (not shown, embodied with reference to the description of the load 41 in FIG. 4), the secondary-side control module turns off the output switch 230 and notifies the primary-side control module (embodied with reference to the description of the primary-side control module 273), such that the output switch 283 is turned on and power stored in the transformer T1 may be supplied to the next set of circuit (e.g. the energy storage unit 282 and the load thereof). The primary-side control module may use the primary-side regulation technique to control the output switch 283 to regulate an output voltage VOUTB of the energy storage unit 282.

The discharge circuit 289 in this embodiment is a transistor Q5, for example. However, the embodiment is not limited thereto. A first end and a second end of the transistor Q5 are respectively coupled with the cathode of the diode D2 and the energy storage unit 282. A control end of the transistor Q5 is coupled with the secondary-side control module 260 (shown in FIG. 2). In this embodiment, the output voltage VOUT is a highest voltage among the output voltage VOUT, the output voltage VOUTA, and the output voltage VOUTB. When it is necessary to release power of the capacitor C2 of the energy storage unit 240, the secondary-side control module 260 controls the transistor Q5 to turn on the transistor Q5, and the power may flow from the transistor Q5 to the VOUTB having a lower voltage, so as to rapidly release energy.

In this embodiment, the synchronous rectifying unit 281 includes a synchronous rectifying diode D1, a resistor R6, and a resistor R7. A cathode and an anode of the synchronous rectifying diode D1 are respectively coupled with the second end of the secondary-side winding 212 and the secondary-side reference voltage (e.g. the secondary-side ground voltage or other fixed voltages). When a cathode voltage of the diode D1 is higher than an anode voltage, the diode D1 is in a turn-off state. Therefore, the synchronous rectifying diode D1 may be considered as a synchronous rectifying switch. A first end of the resistor R6 is coupled with the cathode of the synchronous rectifying diode D1. A first end and a second end of the resistor R7 are respectively coupled with a second end of the resistor R6 and the anode of the synchronous rectifying diode D1. The resistors R6 and R7 are in serial connection for voltage division. The secondary-side control module (details of which may be embodied with reference to the relevant description of the secondary-side control module 260 in FIG. 4) may capture a voltage signal at a monitor point VSYNC where the second end of the resistor R6 and the first end of the resistor R7 are coupled. The secondary-side control module 260 may determine the residual of the power stored in the transformer T1 when the energy-releasing period ends according to the voltage level of the monitor point VSYNC, and correspondingly regulate the time duration of the conduction period of the primary-side control switch 272, i.e. regulate the time duration of the charging period, according to the residual of the power stored in the transformer T1 when the energy-releasing period ends.

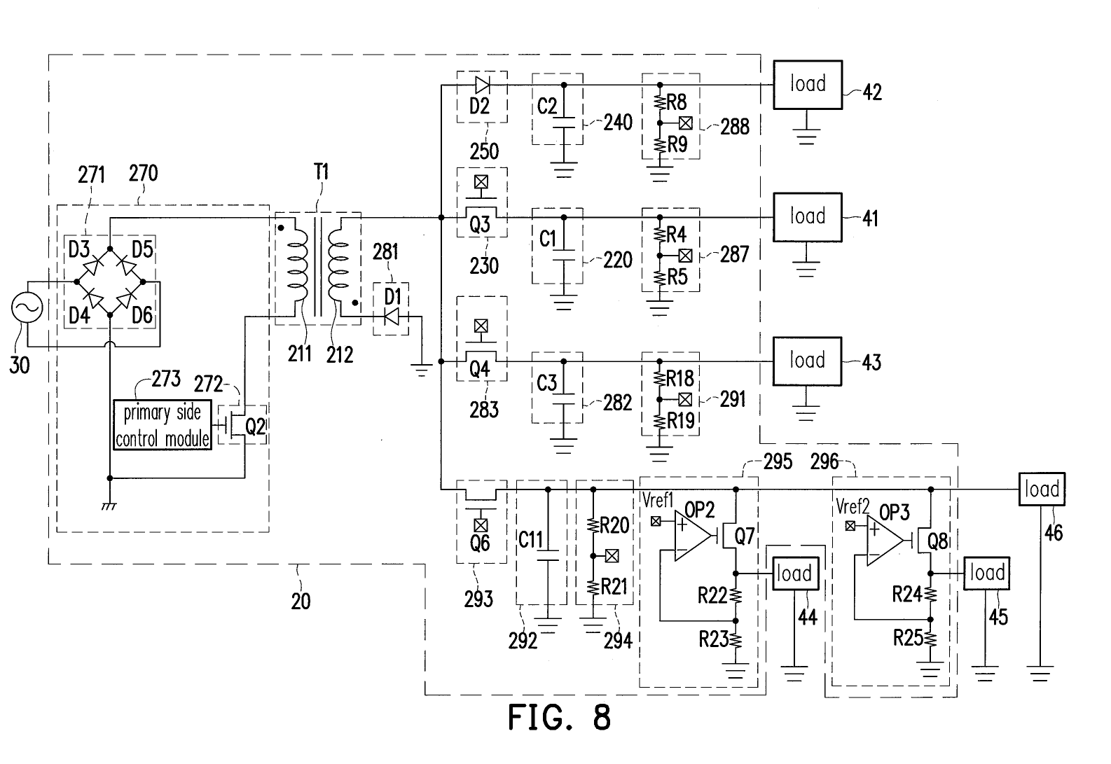

FIG. 8 is a schematic view illustrating a second embodiment of the AC-DC converting apparatus 20 of FIG. 2 according to a fourth embodiment of the invention. The embodiment shown in FIG. 8 may be embodied with reference to the relevant descriptions of FIGS. 4 to 7. The fourth embodiment is an embodiment applied in a monitor system. The fourth embodiment additionally includes an energy storage unit 292, an output switch 293, a monitor circuit 291, a monitor circuit 294, a low-dropout regulator (LDO) 295, and a LDO 296. The fourth embodiment may serve to provide a power source of a scalar board of a monitor system. In this embodiment, the monitor circuit 291 includes resistors R18 and R19. A first end of the resistor R18 is coupled with the first end of the capacitor C3 of the energy storage unit 282 and the second end of the transistor Q4 of the output switch 283. A second end of the resistor R18 is coupled with a first end of the resistor R19. A second end of the resistor R19 is coupled with the secondary-side reference voltage (e.g. the secondary-side ground voltage or other fixed voltages). The monitor circuit 291 serves to divide the voltage of the capacitor C3 of the energy storage unit 282, and transmit a voltage division to the secondary-side control module 260 (as shown in FIG. 2). The secondary-side control module 260 is informed with an electrical characteristic (e.g. voltage) of the energy storage unit 282 according to the voltage division generated by the resistors R18 and R19.

The energy storage unit 292 includes a capacitor C11. The output switch 293 includes a transistor Q6. The monitor circuit 294 includes resistors R20 and R21. A first end of the resistor R20 is coupled with a first end of the capacitor C11 of the energy storage unit 292 and a second end of the transistor Q6 of the output switch 293. A first end of the resistor R21 is coupled with a second end of the resistor R20. A second end of the resistor R21 is coupled with the secondary-side reference voltage (e.g. the secondary-side ground voltage). In addition to providing an output voltage to the load 46, the energy storage unit 292 also provides power to the LDOs 295 and 296. After receiving the power, the LDOs 295 and 296 may respectively output different voltages to the loads 44 and 45.

During the charging period, the power output by the rectifying circuit 271 is stored in the transformer T1 by turning on the primary-side control switch 272. After the charging period ends, the energy-releasing period starts. During the energy-releasing period, the power stored in the transformer T1 may be distributed to the energy storage units 220, 240, 282, and 292.

When the switches 230, 283, and 293 are turned off, the anode voltage of the diode D2 of the output switch 250 is pulled up by the transformer T1, so the power stored in the transformer T1 may be supplied to the load 42 of the energy storage unit 240. When the switches 230, 283, and 293 are turned off, the secondary-side control module 260 (as shown in FIG. 2) monitors the voltage of the energy storage unit 240 and/or monitors the current flowing through the load 42, so as to optimize power output by the energy storage unit 240. For example, the secondary-side control module 260 may maintain the voltage of the storage unit 240 at the nominal voltage level of the load 42. As another example, the secondary-side control module 260 may maintain the current flowing through the load 42 at the nominal current level of the load 42. The load 42 may be a light-emitting diode (LED) backlight module of the monitor, and a voltage output to the load 42 may range between 30V-60V, and a maximal current may be 0.3 A to 0.4 A. However, the invention is not limited thereto. When the power distributed to the energy storage unit 240 reaches the predetermined value, e.g. when the voltage of the energy storage unit 240 reaches the nominal voltage level of the load 42 and/or when the current flowing through the load 42 reaches the nominal current level of the load 42, the secondary-side control module 260 turns on the output switch 230, so as to supply power stored in the transformer T1 to the next set of circuit (i.e. the energy storage unit 220 and the load 41). Since the output switch 230 is conductive, the anode voltage of the diode D2 of the output switch 250 is pulled down. When the cathode voltage of the diode D2 is higher than the anode voltage, the diode D2 is in the turn-off state. Thus, the diode D2 is capable of maintaining the voltage of the capacitor C2 of the energy storage unit 240.

During the conduction period of the output switch 230, the secondary-side control module 260 (as shown in FIG. 2) monitors the voltage of the energy storage unit 220, so as to optimize the power output by the energy storage unit 220. For example, the secondary-side control module 260 may maintain the voltage of the storage unit 220 at the nominal voltage level of the load 41. The load 41 may be an audio module of the monitor. A voltage output to the load 41 may be 5V, and a maximal current may be 1.2 A. However, the invention is not limited thereto. When the power distributed to the energy storage unit 220 reaches the predetermined value, e.g. when the voltage of the energy storage unit 220 reaches the nominal voltage level of the load 41, the secondary-side control module 260 turns off the switch 230 and makes the output switch 283 conductive, so as to supply power stored in the transformer T1 to the next set of circuit (i.e. the energy storage unit 282 and the load 43).

During the conduction period of the output switch 283, the secondary-side control module 260 (as shown in FIG. 2) monitors the voltage of the energy storage unit 282, so as to optimize the power output by the energy storage unit 282. For example, the secondary-side control module 260 may maintain the voltage of the storage unit 282 at the nominal voltage level of the load 43. The load 43 may be a video graphic array (VGA) circuit in the scalar board of the monitor. A voltage output to the load 43 may be 5V, and a maximal current may be 1.5 A. However, the invention is not limited thereto. When the power distributed to the energy storage unit 282 reaches the predetermined value, e.g. when the voltage of the energy storage unit 282 reaches the nominal voltage level of the load 43, the secondary-side control module 260 turns off the output switch 283 and makes the output switch 293 conductive, so as to supply power stored in the transformer T1 to the next set of circuit (i.e. the energy storage unit 292, the load 46, the LDO 295 and LDO 296).

During the conduction period of the output switch 293, the secondary-side control module 260 (as shown in FIG. 2) monitors a voltage of the energy storage unit 292, so as to optimize power output by the energy storage unit 292. For example, the secondary-side control module 260 may maintain the voltage of the energy storage unit 292 at a nominal voltage level of the load 46. The load 46 may be an input/output (I/O) circuit of the scalar board in the monitor. A voltage output to the load 46 may be 3.3V, and a maximal current may be 0.8 A. However, the invention is not limited thereto. When the power distributed to the energy storage unit 292 reaches a predetermined value, e.g. when the voltage of the energy storage unit 292 reaches the nominal voltage level of the load 46, the secondary-side control module 260 turns off the output switch 293.

The LDO 295 includes an amplifier OP2, a transistor Q7, and resistors R22 and R23. A non-inverting input end of the amplifier OP2 receives a reference voltage Vref1. An output end of the amplifier OP2 is coupled with a control end of the transistor Q7. A first end of the transistor Q7 (i.e. a power input end of the LDO 295) is coupled with the capacitor C11 and the transistor Q6. A second end of the transistor Q7 is coupled with a first end of the resistor R22. A second end of the resistor R22 is coupled with an inverting input end of the amplifier OP2 and a first end of the resistor R23. A second end of the resistor R23 is coupled with the secondary-side reference voltage. The second end of the transistor Q7 is an output end of the LDO 295 for supplying power to the load 44. Therefore, the LDO 295 may convert the voltage of the energy storage unit 292 to the nominal voltage of the load 44 according to the reference voltage Vref1. The load 44 may be a dynamic random access memory (DRAM) of the scalar board of the monitor. A voltage output to the load 44 may be 2.5V. However, the invention is not limited thereto.

The LDO 296 includes an amplifier OP3, a transistor Q8, and resistors R24 and R25. A non-inverting input end of the amplifier OP3 receives a reference voltage Vref2. An output end of the amplifier OP3 is coupled with a control end of the transistor Q8. A first end of the transistor Q8 (i.e. a power input end of the LDO 296) is coupled with the capacitor C11 and the transistor Q6. A second end of the transistor Q8 is coupled with a first end of the resistor R24. A second end of the resistor R24 is coupled with an inverting input end of the amplifier OP3 and a first end of the resistor R25. A second end of the resistor R25 is coupled with the secondary-side reference voltage. The second end of the transistor Q8 is an output end of the LDO 296 for supplying power to the load 45. Therefore, the LDO 296 may convert the voltage of the energy storage unit 292 to the nominal voltage of the load 45 according to the reference voltage Vref2. The load 45 may be a core module of the scalar board of the monitor. A voltage output to the load 45 may be 1.2V. However, the invention is not limited thereto. Moreover, in this embodiment, the voltage of the energy storage unit 292 may be the lowest in the voltages of the energy storage units 240, 220, 282, and 292. In this way, the voltage of the energy storage unit 292 may be further closer to the output voltages of the LDOs 295 and 296. Since a voltage difference between input and output voltages of the LDO may be further reduced, the voltage conversion efficiency may be further facilitated.

In view of the foregoing, the embodiments of the invention provide the AC-DC converting apparatus 20 and the operating method thereof. The AC-DC converting apparatus 20 makes use of the secondary-side control module 260 to monitor the energy storage units 220 and 240 and decide or control the time durations of the conduction periods of the output switches 230 and 250 according to the monitoring results. Thus, it only needs the same secondary-side winding 212 of the transformer T1 to generate the plurality of output voltages that are optimizable and precisely regulatable without the need of configuring an additional voltage converter. In addition, in some of the embodiments of the invention, the optical coupling feedback technique and the primary-side regulation feedback technique may be used to feedback, so as to further facilitate the conversion efficiency of the AC-DC conversion apparatus 20 and the operating method thereof.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. An AC-DC converting apparatus, comprising:
a transformer, comprising at least one primary-side winding and at least one secondary-side winding;
a first energy storage unit;
a first output switch, wherein a first end and a second end of the first output switch are respectively coupled with the first energy storage unit and a first end of the secondary-side winding;
a second energy storage unit;
a second output switch, wherein a first end and a second end of the second output switch are respectively coupled with the second energy storage unit and the first end of the secondary-side winding; and
a secondary-side control module, coupled with the first energy storage unit to monitor a first electrical characteristic of the first energy storage unit, and coupled with the second energy storage unit to monitor a second electrical characteristic of the second energy storage unit, wherein the secondary-side control module correspondingly decides a time duration of a conduction period of the first output switch according to a monitoring result of the first electrical characteristic, and correspondingly decides a time duration of a conduction period of the second output switch according to a monitoring result of the second electrical characteristic.

2. The AC-DC converting apparatus as claimed in claim 1, wherein the conduction period of the first output switch and the conduction period of the second output switch are partially overlapped or not overlapped with each other.

3. The AC-DC converting apparatus as claimed in claim 1, further comprising:
a synchronous rectifying unit, wherein a first end and a second end of the synchronous rectifying unit are respectively coupled with a second end of the secondary-side winding and a reference voltage.

4. The AC-DC converting apparatus as claimed in claim 3, wherein the synchronous rectifying unit comprises:
a synchronous rectifying switch, wherein a first end and a second end of the synchronous rectifying switch are respectively coupled with the second end of the secondary-side winding and the reference voltage, and a control end of the synchronous rectifying switch is coupled with the secondary-side control module.

5. The AC-DC converting apparatus as claimed in claim 3, wherein the synchronous rectifying unit comprises:
a synchronous rectifying diode, wherein a cathode and an anode of the synchronous rectifying diode are respectively coupled with the second end of the secondary-side winding and the reference voltage.

6. The AC-DC converting apparatus as claimed in claim 5, wherein the synchronous rectifying unit further comprises:
a first resistor, wherein a first end of the first resistor is coupled with the cathode of the synchronous rectifying diode; and
a second resistor, wherein a first end and a second end of the second resistor are respectively coupled with a second end of the first resistor and the anode of the synchronous rectifying diode.

7. The AC-DC converting apparatus as claimed in claim 1, wherein the second energy storage unit supplies power to a current path of a load, and the AC-DC converting apparatus further comprises:
a current detector, configured on the current path to detect a current of the load and outputting a current detecting result to the secondary-side control module,
wherein the secondary-side control module receives the current detecting result as the monitoring result of the second electrical characteristic.

8. The AC-DC converting apparatus as claimed in claim 1, further comprising:
a third energy storage unit; and
a diode, wherein an anode and a cathode of the diode are respectively coupled with the first end of the secondary-side winding and the third energy storage unit.

9. The AC-DC converting apparatus as claimed in claim 1, wherein the at least one primary-side winding comprises a first primary-side winding, and the AC-DC converting apparatus further comprises:
a rectifying circuit, wherein a first DC end and a second DC end of the rectifying circuit are respectively coupled with a first end of the first primary-side winding and a primary-side reference voltage;
a primary-side control switch, wherein a first end and a second end of the primary-side control switch are respectively coupled with a second end of the first primary-side winding and the primary-side reference voltage;
a primary-side control module, coupled with a control end of the primary-side control switch,
wherein the primary-side control module decides power stored in the transformer by controlling a time duration of a conduction period of the primary-side control switch, and the secondary-side control module decides power released by the transformer by controlling the time durations of the conduction periods of the first output switch and the second output switch.

10. The AC-DC converting apparatus as claimed in claim 9, wherein the primary-side control switch comprises:
a transistor, wherein a first end of the transistor is coupled with the second end of the first primary-side winding, and a control end of the transistor is coupled with the primary-side control module;
a first resistor, wherein a first end and a second end of the first transistor are respectively coupled with a second end of the transistor and the primary-side reference voltage; and
a second resistor, wherein a first end and a second end of the second resistor are respectively coupled with the control end of the transistor and the primary-side reference voltage.

11. The AC-DC converting apparatus as claimed in claim 9, further comprising:
a snubber circuit, wherein a first end and a second end of the snubber circuit are respectively coupled with the first end and the second end of the first primary-side winding.

12. The AC-DC converting apparatus as claimed in claim 11, wherein the snubber circuit comprises:
a resistor, wherein a first end of the resistor is coupled with the first end of the first primary-side winding;
a capacitor, wherein a first end and a second end of the capacitor are respectively coupled with the first end of the primary-side winding and a second end of the resistor; and
a diode, wherein a cathode and an anode of the diode are respectively coupled with the second end of the resistor and the second end of the first primary-side winding.

13. The AC-DC converting apparatus as claimed in claim 9, wherein the AC-DC converting apparatus further comprises:
a chip startup circuit, wherein two ends of the chip startup circuit are respectively coupled with the first DC end of the rectifying circuit and the primary-side control module.

14. The AC-DC converting apparatus as claimed in claim 13, wherein the at least one primary-side winding further comprises a second primary-side winding, and the chip startup circuit comprises:
a resistor, wherein a first end of the resistor is coupled with the first DC end of the rectifying circuit and the first end of the first primary-side winding, and a second end of the resistor is coupled with the primary-side control module;
a diode, wherein a cathode and an anode of the diode are respectively coupled with the second end of the resistor and a first end of the second primary-side winding; and
a capacitor, wherein a first end and a second end of the capacitor are respectively coupled with the second end of the resistor and the primary-side reference voltage, and
wherein a second end of the second primary-side winding is coupled with the primary-side reference voltage.

15. The AC-DC converting apparatus as claimed in claim 9, further comprising:
a feedback module, wherein a sensing end of the feedback module is coupled with the second energy storage unit to monitor a third electrical characteristic of the second energy storage unit, an output end of the feedback module is coupled with the primary-side control module to provide a corresponding information of the third electrical characteristic, and the primary-side control module correspondingly decides the time duration of the conduction period of the primary-side control switch according to the corresponding information.

16. The AC-DC converting apparatus as claimed in claim 15, wherein the feedback module comprises:
a first resistor, wherein a first end of the first resistor is coupled with the second energy storage unit;
a second resistor, wherein a first end and a second end of the second resistor are respectively coupled with a second end of the first resistor and a secondary-side reference voltage;
a third resistor, wherein a first end of the third resistor is coupled with the second energy storage unit;
a first capacitor, wherein a first end of the first capacitor is coupled with the second end of the first resistor;
a Zener diode, wherein a cathode and an anode of the Zener diode are respectively coupled with a second end of the first capacitor and the secondary-side reference voltage;
an optical coupler, wherein a first end and a second end of a light-emitting part of the optical coupler are respectively coupled with a second end of the third resistor and the second end of the first capacitor, and a first end and a second end of a light-sensing part of the optical coupler are respectively coupled with the primary-side control module for providing the corresponding information and the primary-side reference voltage; and
a second capacitor, wherein a first end and a second end of the second capacitor are respectively coupled with the first end and the second end of the light-sensing part of the optical coupler.

17. The AC-DC converting apparatus as claimed in claim 9, wherein the primary-side control module and the secondary-side control module are disposed in the same integrated circuit.

18. The AC-DC converting apparatus as claimed in claim 1, wherein the secondary-side control module is coupled with a second end of the secondary-side winding to monitor a voltage characteristic, and the secondary-side control module correspondingly controls a conducting timing of the first output switch according to a monitoring result of the voltage characteristic.

19. The AC-DC converting apparatus as claimed in claim 1, further comprising a low-dropout regulator, wherein a power input end of the low-dropout regulator is coupled with the second energy storage unit.

20. The AC-DC converting apparatus as claimed in claim 19, wherein a voltage of the second energy storage unit is a lowest voltage among voltages of the plurality of energy storage units of the AC-DC converting apparatus.

21. An operating method of an AC-DC converting apparatus, comprising:
configuring a transformer in the AC-DC converting apparatus, wherein the transformer comprises at least one primary-side winding and at least one secondary-side winding;
configuring a first energy storage unit and a first output switch in the AC-DC converting apparatus, wherein a first end and a second end of the first output switch are respectively coupled with a first end of the secondary-side winding and the first energy storage unit;
configuring a second energy storage unit and a second output switch in the AC-DC converting apparatus, wherein a first end and a second end of the second output switch are respectively coupled with the second energy storage unit and the first end of the secondary-side winding;
transmitting power stored in the transformer to the first energy storage unit during a conduction period of the first output switch, monitoring a first electrical characteristic of the first energy storage unit, and correspondingly deciding a time duration of the conduction period of the first output switch according to a monitoring result of the first electrical characteristic; and
transmitting the power stored in the transformer to the second energy storage unit during a conduction period of the second output switch, monitoring a second electrical characteristic of the second energy storage unit, and correspondingly deciding a time duration of the conduction period of the second output switch according to a monitoring result of the second electrical characteristic.

22. The operating method of the AC-DC converting apparatus as claimed in claim 21, further comprising:
configuring a rectifying circuit in the AC-DC converting apparatus, wherein a first DC end and a second DC end of the rectifying circuit are respectively coupled with a first end of the primary-side winding and a primary-side reference voltage;
configuring a primary-side control switch in the AC-DC converting apparatus, wherein a first end and a second end of the primary-side control switch are respectively coupled with a second end of the primary-side winding and the primary-side reference voltage; and
during a charging period, storing power output by the rectifying circuit into the transformer by turning on the primary-side control switch.

23. The operating method of the AC-DC converting apparatus as claimed in claim 22, wherein the charging period, the conduction period of the first output switch and the conduction period of the second output switch are not overlapped with each other.

24. The operating method of the AC-DC converting apparatus as claimed in claim 21, further comprising:
detecting a voltage at a second end of the secondary-side winding, and when the second end of the secondary-side winding is at a negative voltage level, sequentially turning on the first output switch and the second output switch.
